(19) United States
(12) Patent Application Publication
(10) Pub. No.: US 2005/0054325 A1
(43) Pub. Date: Mar. 10, 2005

(54) Method for authenticating and charging a subscriber of a radio network

(76) Inventor: Hans-Jochen Morper, Erdweg (DE)

Correspondence Address: STAAS & HALSEY LLP, SUITE 700, 1201 NEW YORK AVENUE, N.W., WASHINGTON, DC, 20005, US

(21) Appl. No.: 10/494,272

(22) PCT Filed: Nov. 3, 2003
(86) PCT No.: PCT/EP03/12255

(30) Foreign Application Priority Data
Nov. 26, 2002 (EP) 02026272.1

(51) Int. Cl. H04M 11/00

(52) U.S. Cl. 455/410; 455/466; 455/405

(57) ABSTRACT

A subscriber to a wireless communications network is authenticated and charged for communication between subscriber's line equipment and the wireless communications network by using a mobile radio communications system including a mobile radio communications network and a mobile station belonging to the subscriber. Information identifying at least one of the subscriber and the mobile station is transferred via the subscriber's line equipment by the wireless communications network to the mobile radio communications network, or the mobile station sends the mobile radio communications network a signal, as a result of which the mobile radio communications network sends the mobile station a chargeable short message containing information for accessing the wireless communications network. The charge for the communication between the subscriber's line equipment and the wireless communications network is applied by charging for the short message in the mobile radio communications network. The operators of the wireless communications network and the mobile radio communications system are not involved in any additional investment in new modules.

### CROSS REFERENCE TO RELATED APPLICATIONS

This application is based on and hereby claims priority to European Application No. 02026272.1 filed on Nov. 26, 2002, the contents of which are hereby incorporated by reference.

### BACKGROUND OF THE INVENTION

1. Field of the Invention

The invention relates to a method for authenticating a subscriber to a first wireless communications network and for applying a charge to a communication between a subscriber's line equipment and the first wireless communications network by using a mobile radio communications system.

2. Description of the Related Art

There is known to be a multiplicity of widely differing types of telecommunications and data networks for communicating or transmitting data. In this connection a distinction has to be made between two basically different types of network. On the one hand there are the mobile radio communications systems, such as those operating according to the standards known as GSM (global system for mobile telecommunications) or UMTS (universal mobile telecommunications system), in which mobile stations are authenticated and authorized upon registering in the network concerned. The advantage of such networks is that authentication also makes it possible to apply a charge for the services used. In addition these networks, which are usually cellular, offer a high degree of mobility, since subscribers can move with their mobile stations from one network cell to another. The disadvantage of such cellular mobile radio communications systems is that the management costs are very high. In addition these systems provide the radio interfaces to subscribers' mobile stations with only a relatively low data transfer rate.

In mobile radio communications systems, information such as speech, pictures, videos, short messages (SMS, short message service) or other data is transmitted between the sending and receiving stations over a radio interface with the aid of electromagnetic waves. The electromagnetic waves are emitted on carrier frequencies that lie within the intended frequency band for the system concerned. In this case a radio communications system includes subscriber stations, such as mobile stations, and base stations, such as B nodes, together with other installations within the network itself. Thus the base stations and the network installations form the mobile radio communications network. In a radio communications system the subscriber stations and the base stations are interconnected over a radio interface.

On the other hand there are networks designed as local area networks (LANs) or wireless local area networks (WLANs). Such networks provide subscribers' telephone stations with a form of access in which the management technology is very simple. A further advantage compared to mobile radio communications networks is the considerably higher data transfer rate on the interfaces to subscribers' mobile stations. The disadvantage of such local area networks, however, is the lack of any authentication facility and thus of any facility to apply charges.

The term local area network usually refers to communication networks extending from a few tens of meters up to as much as ten kilometers. However, most LANs extend for only a few hundred meters within buildings or organizations (in-house networks).

WLANs enable communication between for example a hard-wired network infrastructure and mobile computers (e.g. laptops). WLANs are often used as extensions of hard-wired LANs in certain working environments. As a rule WLANs include different access points (APs) which are interconnected via a hard-wired LAN and in which data is transported from a mobile transmitter via a radio link to the AP and then forwarded via the LAN. Cells covered by WLANs have a diameter of up to one hundred meters and are so small compared to the usual mobile radio cells that they are known as micro-cells.

Examples of the different standards for WLANs are HiperLAN, DECT, IEEE 802.11, Bluetooth and WATM. However at the moment, particularly in the USA and Europe, products based on the IEEE 802.11 family appear to be gaining almost exclusive acceptance as wireless local area networks, to the extent that the appropriate Ethernet connections are already installed as standard in many computers and in portable computers such as laptops, Notebooks and PDAs. Radio interfaces defined according to the IEEE 802.11b standard for access to local area networks correspond functionally to a wired connection to local area networks (LANs), which nowadays have become standard in offices. Interface cards for wireless access to local area networks are also known as network interface cards (NICs). From the design point of view they are manufactured in the same way as standard Ethernet cards and can be installed in modern operating systems by the method known as Plug & Play. It is no problem to fit the appropriate interface cards to portable computers if they have not already been delivered ex-works with a built-in port for wired or wireless access to local area networks. In the case of the current and next generation of operating systems (such as Windows XP from Microsoft), fully integrated support is provided for wireless local area networks (WLANs).

WLANs generally use the non-licensed frequency range around 2.4 GHz and 5 GHz. Data transfer rates are up to 11 Mbit/s. Future WLANs could be operated in the 5 GHz range and data transfer rates of over 50 Mbit/s could be achieved. Given current data rates of 11 Mbit/s and future rates of 50 Mbit/s, the data transfer rates available to WLAN subscribers are significantly higher than those which can be offered by the emerging, third generation of mobile radio communications systems (e.g. UMTS). For transferring large quantities of data, therefore, especially in combination with access to the Internet, access to wireless local area networks (WLANs) is often preferred for high bit-rate connections.

WLANs are being used to an ever-increasing extent in hotels, airports, exhibitions and other places with high volumes of visitors. An important factor for the success of WLANs is the authentication and charging of subscribers. It is a disadvantage to wireless local area networks that they can offer no authentication facility for stations or computers not already registered in the system. However, operators of WLANs in airports, for instance, need to make access available to many and varied subscribers from widely differing regions. To be able to authenticate subscribers, WLAN operators would have to enter into cross-license agreements with all possible internet service providers (ISPs), of which there are over 60,000 in Germany alone at the present time.

However, without a facility to authenticate subscribers or their telephone stations it is impossible to apply a charge for the services used in WLANs, since there is no way of knowing who should be billed. Access to wireless local area networks must therefore be offered either without payment or as a prepaid service charged to a credit card or similar.

For the operators of the mobile radio communications systems described previously, these problems are very easily solved. Cellular mobile radio communications networks have a large number of mobile subscribers, who can be authenticated. In addition these mobile radio communications networks have charging and billing systems. Using a method known as international roaming it is even possible to authenticate and serve subscribers who are registered with or subscribe to another mobile radio communications operator. Since nowadays a large proportion of consumers in the developed countries are mobile subscribers, mobile radio communications operators can in principle address almost every consumer through their own individual networks or through those of other mobile system operators.

There are many ways in which a mobile radio communications operator can integrate a WLAN into its cellular mobile radio communications network. In the present state of discussions the basic distinction is between tight and loose coupling. Tight coupling means complete UMTS integration, that is, only physical layer of the WLAN is used, apart from which all the higher protocol layers are handled and optimized by UMTS. This solution is no longer under discussion, having turned out to be technically difficult to accomplish and not very promising from the commercial point of view.

In loose coupling two infrastructure-based variants are currently under public discussion, based on using either a registered identification card known as a subscriber identification module (SIM) or the protocol known as remote access dial-in user access (RADIUS). In SIM-based variants a SIM card is installed in a Notebook or in a network access card dedicated to it. Typically the WLAN is regarded as a visitor local register (VLR) of the mobile radio communications system, and is linked to the mobile radio communications network by the mobile application part (MAP) as it is known. Commercial success for the operators of mobile radio communications networks is therefore heavily dependent on whether in the future every card for accessing wireless local area networks will include a SIM card as standard. For this to happen it would be necessary for computer manufacturers and the standardization committees for data networks and telecommunications networks to develop common standards, or a mobile radio communications operator would have to subsidize this special type of NIC.

In the RADIUS variants the mobile radio communications network is typically regarded as an authentication, authorization and charging server of the WLAN, so that there is no need to modify the subscriber equipment in the WLAN.

In another approach, a WLAN subscriber enters his/her mobile subscriber ISDN number (MSISDN) into a WLAN page composed in hypertext markup language (HTML), and the WLAN transmits the information to the mobile radio communications system. The mobile radio communications system then sends a password by SMS to the mobile station of the WLAN subscriber, and this is used to control access to the WLAN. This procedure ensures that only those subscribers who also possess a valid subscription to the mobile radio communications system receive access to the WLAN.

Particularly in terrestrial GSM mobile radio communications, the abbreviation SMS means a standardized service for the unidirectional transmission of messages with a limited length. Short messages are text messages which do not exceed a defined maximum number of characters.

Though this facility solves the problem of authenticating WLAN subscribers, an effective method of charging must still be found. A method which has been suggested involves the charging information being transferred from the WLAN to a facility known as a wallet server and also to the operator of the mobile radio communications system. The latter can be performed by coupling the WLAN to a micro-payment system in the mobile radio communications network.

However, the charging methods described require the WLAN to be provided with additional hardware. This approach therefore conflicts with the economic interests of the WLAN operator.

### SUMMARY OF THE INVENTION

An object of the invention is to demonstrate a method of the kind initially set out above, which enables the effective and inexpensive authentication and charging of a subscriber to a wireless communications network by using a mobile radio communications system.

According to the invention, information identifying the subscriber and/or mobile station is transferred via the subscriber's line equipment by the first wireless communications network to the mobile radio communications network, or the mobile station sends the mobile radio communications network a signal, as a result of which the mobile radio communications network sends the mobile station a chargeable short message which contains information for accessing the first wireless communications network, and the charge for the communication between the subscriber's line equipment and the first wireless communications network is applied via the charging procedure for the short message in the mobile radio communications network.

The first wireless communications network constitutes in particular a wireless local area network, that is, a WLAN. In principle, however, the method can also be applied to other wireless communications networks. The signal which the mobile station sends to the mobile radio communications network is designed so that the mobile radio communications network recognizes that the subscriber is requesting information for accessing the first wireless communications network. The short message which the mobile radio communications network sends the mobile station contains the access information as a minimum. It may also however contain other information. The access information can be used by the first wireless communications network for the purpose of deciding whether the subscriber shall have access to this first wireless communications network. Thus, the access information enables the subscriber to communicate with the first wireless communications network via the subscriber's line equipment. The charge for the short message is applied in the mobile radio communications network with the aid of a suitable charges account. This may be a charges account relating to the subscriber, or it may relate to other charges accounts, possibly including accounts defined for a group of subscribers, for example.

The method to which the invention relates exhibits a number of advantages:
The operator of the mobile radio communications system can cost-effectively, that is at no additional expense, connect WLANs from third-party providers to its in-house mobile radio communications network.
Subscribers are accustomed to SMS-based user information, and therefore need no conversion to a novel technology.
Any risk that the WLAN operator may send bills to persons who do not exist is removed.
The one-time payment for the short message is a flat rate, which as a rule is viewed as a desirable form of payment by subscribers.
The desired WLAN service can be taken up as soon as the short message is received.
The operator of the mobile radio communications system can use the demand for services in the WLAN to test the demand for the corresponding UMTS services that will be available in the future.
The operators of the mobile radio communications system and the WLAN are not involved in any additional investment in new modules.
Subscribers show greater readiness to take up further chargeable services via the same charging method. For example when a subscriber has accessed the WLAN, certain Internet services can be charged for by charging for another short message in the mobile radio communications network. In this case therefore the method of charging for a communication between the subscriber's line equipment and the first wireless communications network is performed again in respect of a particular communication, once the subscriber has been authenticated in accordance with the method to which the invention relates and a first charging method to which the invention relates has taken place. The access information then refers to the further chargeable service requested by the subscriber. The method to which the invention relates can thus if necessary be used repeatedly, producing a graduation of charges.

In one embodiment of the invention, the short message is charged for in the mobile radio communications network after the short message has been received by the mobile station. In this case therefore charging is independent of the use which the subscriber makes of the access information. The charge can be applied to the appropriate charges account as soon as the subscriber has received the chargeable short message on his/her mobile station.

Advantageously, the charge for the short message within the mobile radio communications network is applied once the short message is opened. In this event, before the subscriber opens the short message a prompt can ask whether he/she wishes to open this chargeable short message. This can ensure that a subscriber does not have to pay charges for a short message which he/she does not wish to use or look at, or did not intentionally request.

In a further embodiment of the invention, the short message is charged for in the mobile radio communications network once use has been made of the access information in the first wireless communications network. This ensures that the subscriber to the first wireless communications network is only charged after using the access information to start a communication with the first wireless communications network. In this case therefore the subscriber can have the mobile radio communications network send a short message containing the access information without actually using it. In such an event no charge would be raised.

Advantageously, the information identifying the subscriber and/or the mobile station can be the mobile station call number. In this way the mobile radio communications network finds out directly the call number to which the chargeable short message should later be sent. It is also conceivable for the name of the subscriber or an identification number such as the international mobile subscriber identity (IMSI) to be sent, so that the mobile radio communications network can use this information to determine the call number to which the chargeable short message should be sent.

In a preferred embodiment of the invention the mobile station sends the mobile radio communications network the signal, using a call number which belongs to the mobile radio communications network and is used for authenticating and charging the subscriber to the first wireless communications network. This may be a special call number which belongs to an intelligent network and which has been set up expressly for the purpose of authenticating and charging within another wireless communications network. From this special call number the mobile radio communications network recognises which requests the subscriber is making, namely the transfer of the chargeable short message containing the identification information.

Advantageously, the call number is a free call number.

According to an embodiment of the invention the charge for the short message depends on the service requested by the subscriber in the first wireless communications network. Charging for the communication between the subscriber's line equipment and the first wireless communications network by charging for the short message in the mobile radio communications network corresponds to flat-rate charging for the communication between the subscriber's line equipment and the first wireless communications network. Accordingly a higher charge for a service requiring a high data transfer rate seems appropriate. As a rule the charge for the short message containing the access information should be higher than a normal charge for other short messages sent in the mobile radio communications system.

In a preferred embodiment of the invention the mobile radio communications network sends the access information to the first wireless communications network. The first wireless communications network can then compare the access information received from the mobile radio communications network with the access information of the subscriber's line equipment and decide whether to allow the subscriber to access the first wireless communications network. It is also possible for both the mobile radio communications network and the first wireless communications network to have a list of valid access information. The mobile radio communications network then selects an access information from this list and sends it to the mobile station via the chargeable short message.

### BRIEF DESCRIPTION OF THE DRAWINGS

These and other objects and advantages of the present invention will become more apparent and more readily appreciated from the following description of a typical embodiment, taken in conjunction with the accompanying drawings of which:

FIG. 1 is a flowchart of a method to which the invention relates,

FIG. 2 is a block diagram of a mobile radio communications system, and

FIG. 3 is a block diagram of a wireless local area network and a mobile radio communications network.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

This typical embodiment considers a subscriber who subscribes to a mobile radio communications system. This subscriber is located, together with a mobile station and a laptop, in the radio coverage area of a WLAN. The subscriber wishes to make use of the services provided by the local area network. Since the operator of the WLAN does not wish to make the local area network available free of charge, it is necessary to carry out a method for authenticating and charging the subscriber.

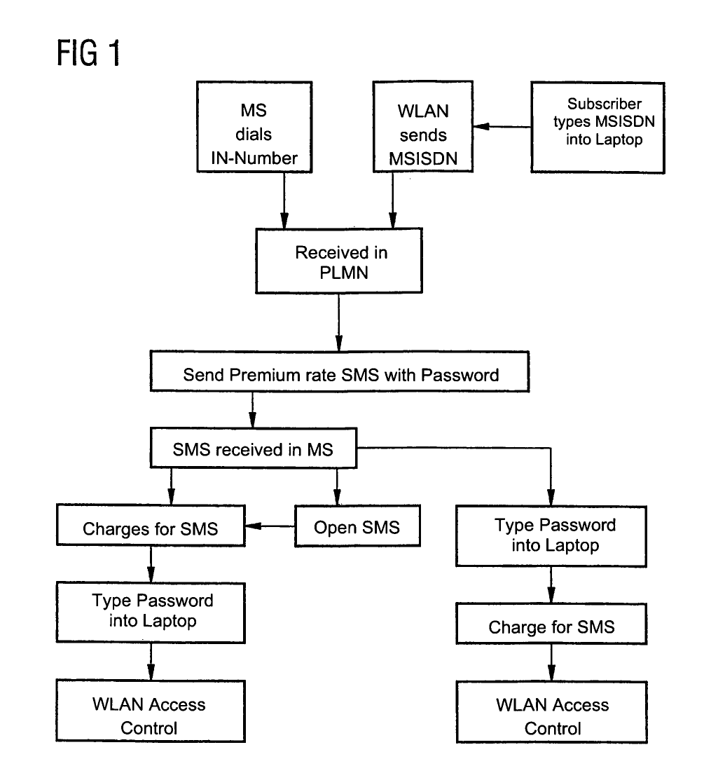

A flowchart of a method for authenticating and charging, to which the invention relates, is shown in FIG. 1. At the start of the method the subscriber has two options: one, in response to a prompt from the WLAN, is to advise the WLAN of his/her mobile call number (“Subscriber types MSISDN into laptop”), whereupon the WLAN sends this number to the mobile radio communications system (“WLAN sends MSISDN”). By virtue of the message from the WLAN, the mobile radio communications network recognizes that the subscriber is requesting access to the WLAN.

Alternatively, the subscriber can use his/her mobile station to dial the number of a special intelligent network (IN) service (“MS dials IN number”). Nowadays mobile radio communications networks usually have an intelligent network which can be used to provide their mobile radio communications customers with supplementary services such as call forwarding to a speech mailbox. As a rule these systems have a service switching point and a service control point. The former recognizes from the call number dialed that an IN service is being requested. The latter recognises the desired service, enabling it to be provided and a charge to be applied. Service control points are implemented on server platforms as a rule. By virtue of the number dialed, the mobile radio communications network recognizes that the subscriber is requesting access to the WLAN.

After receiving the information about the request for access information (“Received in PLMN”), the mobile radio communications network sends the subscriber's mobile station a premium-rate SMS containing a one-time password for use in the WLAN (“Send premium-rate SMS with password”). A premium-rate SMS is distinguished by its higher cost compared to a normal SMS. The cost charged to the subscriber for the premium-rate SMS is therefore increased compared to the normal cost for a SMS (e.g. 19 Euro cents) by a charge corresponding to the service requested in the WLAN (e.g. 10 Euro per day for WLAN access). The subscriber thus pays only a single charge for using the WLAN. There is no need to record the time spent using the WLAN or the quantity of data transferred. It is therefore possible to do away with the charging systems which are otherwise normally used. However, with the aid of the IN number or by transferring the MSISDN, it is possible to inform the mobile radio communications network which kind of service the subscriber wishes to use, so that the price of a premium-rate SMS can be varied according to the service category.

Once the mobile station has received the premium-rate SMS (“SMS received in MS”), there are different options for the moment at which to apply the charge. In the simplest case charging can be carried out directly after receipt of the SMS (“Charge for SMS”). In this example therefore the sum of 10.19 Euro is debited to the credit balance account assigned to the subscriber in the mobile radio communications system. Another option is to apply the charge at the moment when the subscriber opens the premium-rate SMS (“Open SMS”). This can also be linked to a security prompt before the premium-rate SMS is opened, so that the subscriber is made aware before opening the premium-rate SMS that an increased cost will be incurred on opening the short message. A further option is to apply the charge when the subscriber uses the password in the WLAN (“Type password into laptop”). In the latter case the WLAN must inform the mobile radio communications network that the password has been used. This can also be achieved if parts of the WLAN are also a component of the mobile radio communications system, so that there is no necessity for the WLAN to inform the mobile radio communications network.

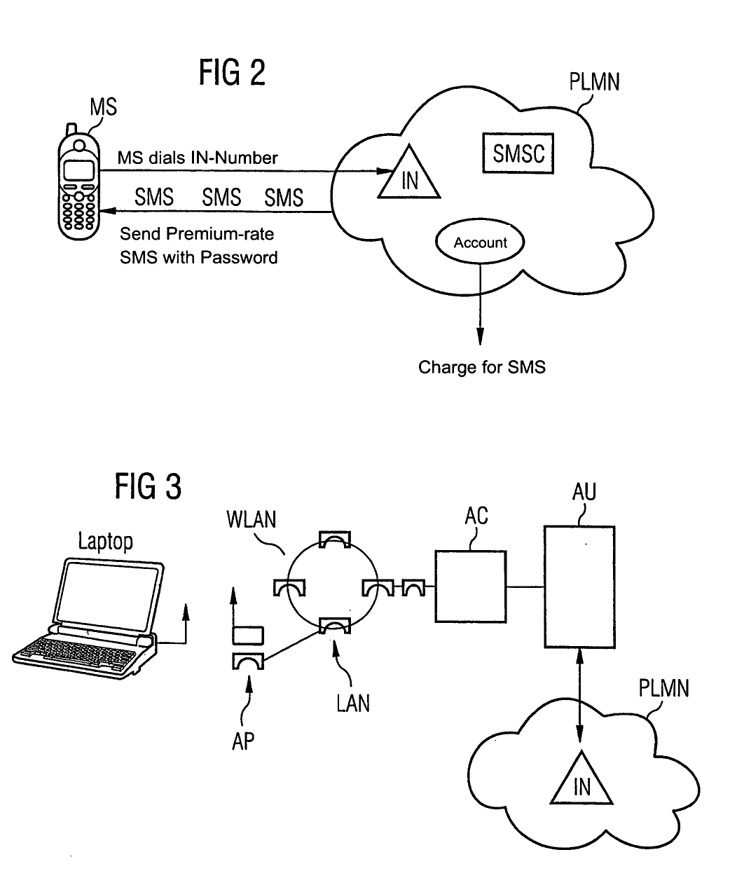

FIG. 2 shows a diagram of the flow between the mobile station MS and the mobile radio communications network PLMN. The mobile station MS dials the appropriate number of the intelligent network IN, which is a component of the mobile radio communications network PLMN (“MS dials IN number”). The mobile radio communications network PLMN accordingly sends the mobile station MS a premium-rate SMS containing a valid password for the WLAN (“Send premium-rate SMS with password”). A facility SMSC (short message service center) is involved in sending the SMS. The facility SMSC handles the dispatch of short messages and forwards charging information about the short messages to a charging system in the mobile radio communications network PLMN. The mobile radio communications network PLMN operates a credit balance account ACCOUNT for the subscriber. The charge incurred for the premium-rate SMS is deducted from this credit balance account ACCOUNT (“Charge for SMS”).

To access the WLAN, the subscriber types into the laptop the password sent by the mobile radio communications network (“Type password into laptop” in FIG. 1). The password can be entered with or without the MSISDN via an input mask on the laptop. The WLAN can then decide whether to allow the subscriber to have access (“WLAN access control”).

FIG. 3 shows the computer LAPTOP, which is connected to a WLAN access point AP by a radio link. In this instance, the computer LAPTOP stands for any suitable subscriber's line equipment which is capable of communicating with the wireless local area network by radio. The WLAN has a plurality of devices which are interconnected by radio or by lines. The devices include routers and bridges for distributing data to a plurality of subscriber's line equipment sets. The part of the WLAN that is connected by lines constitutes a LAN. The password is sent by the computer LAPTOP by radio to the access point AP, from where it goes via lines to an authentication unit AU.

The authentication unit AU compares the password received from the computer LAPTOP with information which has been sent to it by the mobile radio communications network PLMN. For this purpose the mobile radio communications network PLMN has a password service unit which sends valid passwords to the WLAN. The password service unit can generate these passwords if necessary. Valid passwords can be sent to the WLAN periodically, for instance daily, or ad hoc, that is on request. For example a valid password list can be sent to the WLAN once a day. If a password has been used, it is deleted from the list in the WLAN and in the mobile radio communications network PLMN. The mobile radio communications network PLMN can thus send a password to the WLAN before sending it to the mobile station MS, or even at about the same time, depending on the kind of coupling between the WLAN and the mobile radio communications system. The authentication unit AU may also be part of an appropriate IN service.

The authentication unit AU can clear an access control unit AC following successful authentication for the provision of a WLAN service. The authentication unit AU and the access control unit AC can be together on the same platform or may be separate. Following clearance the computer LAPTOP can communicate with or through the WLAN, according to the service requested.

The invention has been described in detail with particular reference to preferred embodiments thereof and examples, but it will be understood that variations and modifications can be effected within the spirit and scope of the invention.

1-9. (cancelled).

10. A method for authenticating a subscriber to a wireless communications network and for applying a charge to communication between subscriber line equipment of the subscriber and the wireless communications network, by using a mobile station belonging to the subscriber and a mobile radio communications network, comprising:
obtaining in the mobile communications network identifying information for at least one of the subscriber and the mobile station by one of
sending the identifying information via the subscriber line equipment and the wireless communications network to the mobile radio communications network, and
sending a signal from the mobile station to the mobile radio communications network;
receiving at the mobile station a short message from the mobile radio communications network containing access information for accessing the wireless communications network; and
applying a charge for the communication between the subscriber line equipment and the wireless communications network, by charging for the short message in the mobile radio communications network.

11. A method according to claim 10, wherein said applying charges for the short message in the mobile radio communications network after the short message has been received by the mobile station.

12. A method according to claim 10, wherein said applying charges for the short message in the mobile radio communications network after the short message has been opened.

13. A method according to claim 10, wherein said applying charges for the short message in the mobile radio communications network after the access information has been used in the wireless communications network.

14. A method according to claim 13, wherein the identifying information for the at least one of the subscriber and the mobile station is a first call number of the mobile station.

15. A method according to claim 14, wherein said sending of the signal from the mobile station to the mobile radio communications network uses a second call number which belongs to the mobile radio communications network and is used for authenticating and charging the subscriber of the wireless communications network.

16. A method according to claim 15, wherein the second call number is a free call number.

17. A method according to claim 16, wherein said applying the charge by charging for the short message uses an amount based on a service of the wireless communications network requested by the subscriber.

18. A method according to claim 17, further comprising sending the access information from the mobile radio communications network to the wireless communications network.
